(19) United States
(12) Patent Application Publication
(10) Pub. No.: US 2017/0200379 A1
(43) Pub. Date: Jul. 13, 2017

(54) SECURITY SYSTEM FOR AN AIRCRAFT AND COMMUNICATION METHOD USING THE SECURITY SYSTEM

(71) Applicant: Gaetano RIZZI, Venezia (IT)

(72) Inventor: Gaetano RIZZI, Venezia (IT)

(21) Appl. No.: 15/316,450

(22) PCT Filed: Jun. 5, 2015
(86) PCT No.: PCT/IB2015/054264

§ 371 Date: Dec. 5, 2016

(30) Foreign Application Priority Data
Jun. 5, 2014 (CH) 00860/14

(51) Int. Cl. G08G 5/00; H04B 5/00; H04W 4/04; B64D 45/00; G01S 19/42; G05D 1/00; G05D 1/04; G01S 5/00; G01S 19/16; G01S 19/17; H04B 7/185; G07C 5/00

(52) U.S. Cl. CPC G08G 5/0056; H04B 7/18506; H04B 5/0031; H04W 4/046; G08G 5/0021; B64D 45/0015; G07C 5/008; G08G 5/0013; G08G 5/0008; G05D 1/0011; G05D 1/042; G01S 5/0009; G01S 5/0027; G01S 19/16; G01S 19/17; G01S 19/42; B64D 2045/0045; B64D 2045/0055; G01S 2205/006

(57) ABSTRACT

Communication method for an aircraft (1) comprising the steps of:
installing a security system (100 or IDDS) in a non-pressurized zone (2) of the aircraft (1), said security system (100) comprising a GPS localization device (101) with satellite link and an autonomous battery (102);—detecting in the GPS localization device (101) at least one position (A) of the aircraft;—sending the position (A) to a control station (200) interconnected with the satellite link; said steps of detecting and sending the position (A) being performed if an anomaly is detected.

### FIELD OF APPLICATION

The present invention relates to a security system for an aircraft and to a communication method using the security system. The system and the communication method according to the present invention have the function of informing a control station as to the position of the aircraft in particular emergency conditions, for example when the aircraft has been hijacked or in the event of a sudden malfunction or fault affecting the on-board devices of the aircraft or when a predefined altitude not programmed and incompatible with the safety of the aircraft is reached.

In particular, the invention relates to a method which allows communication also when the analog and/or digital transmission systems of the aircraft in flight are voluntarily or involuntarily isolated.

### PRIOR ART

Methods for communication between an aircraft and a control station are known, for example methods for transmission of electromagnetic waves transmitted from a primary radar of the station which subsequently receives the waves reflected back by the aircraft, in order to identify the position of the aircraft. These methods of communication are limited by the fact that the primary radar is subject to inference, for example owing to the atmospheric conditions, and is unable to detect the aircraft beyond the range of the radar, and therefore is not suitable for communication between the aircraft and the station in emergency conditions.

Also known are secondary radars of the control station, which transmit to a transceiver or transponder of the aircraft, which responds with a digital signal which allows it to located by the station more accurately and over greater distances than is possible with a primary radar.

Also known are global positioning systems (GPS) which may be used to detect the position of an aircraft via a network of orbiting artificial satellites. The position detected may be transmitted to the control station via an analog or digital transmission system of the aircraft.

All the known communication methods, including those transmitting the position detected by the global positioning system, are limited by the fact that, in certain anomalous conditions of the aircraft, they are no longer able to transmit to the control station or receive from it.

This has already been confirmed in the past, during hijackings, where the devices on-board the aircraft, including the aforementioned analog or digital transmission systems, have been manually deactivated, interrupting the communication between aircraft and station. In some cases, the interruption in communication has occurred owing to a fault in the on-board devices and not because of tampering.

In all these cases, the interruption in the communication resulted in considerable problems and difficulties in tracing the aircraft, which sometimes was found only after impact with the ground, thousands of kilometres away from the last known position or the position in which it was thought it could be found.

The technical problem forming the basis of the present invention is that of keeping always active communication between the aircraft and the control station, in order to be able to identify always its position, even in anomalous conditions of the on-board devices or their electrical power supply systems, for example the analog or digital transmission systems, or in the case of a hijacking, up to the moment, if necessary, of impact with the ground, thus allowing immediate action in an emergency situation, reducing significantly the time needed for recovery of the aircraft, with enormous savings in terms of costs and solving the drawbacks which hitherto affect the known communication systems and methods.

### SUMMARY OF THE INVENTION

The idea underlying the present invention is to install a security system comprising satellite transmission/reception means, but also other means, in a section of an aircraft which is inaccessible, especially when flying, ensuring that the security system is always undamaged and cannot be tampered with before, after or during the flight, is always powered and is always able to communicate with a control station, especially when the on-board devices are not working or isolated, or when the cockpit is inaccessible and its devices uncontrollable, for example in the case where a hijacker isolates him/herself in the cockpit with or without the pilot(s), preventing access thereto.

According to one aspect of the invention, the security system is programmed to ensure the safety of the aircraft when flying, keeping it on a given flight path or at an altitude which prevents collisions or damage and allowing at the same time the approach of other aircraft equipped and authorized to recover the aircraft, bringing it back down onto the ground. In particular, the idea of the invention is also that of maintaining a safe flight path of the aircraft in the event of anomalous conditions being identified, this flight path being maintained irrespective of the actions or the commands issued to the aircraft by the cockpit, therefore allowing the security systems to take over and replace the pilot's commands until the aircraft authorized to escort it back onto the ground arrives, thereby safeguarding the lives of the persons on-board and the merchandise transported.

The section of the aircraft in which the security system is intended to be installed is a non-pressurized zone of the aircraft; this zone is not accessible to persons during the flight, also owing to the considerable difference in pressure compared to the pressurized zone, which would result in an explosive decompression in the event of the two zones communicating with each other. Preferably, the security system is installed in the non-pressurized zone and behind a sealed door or inside safe which can be opened only by means of a combination or a special or encrypted key, and the removal without said combination or key results in structural damage to the aircraft preventing operation thereof, for example take-off.

According to one aspect of the present invention, the security system is programmed to remain in standby mode during flight, where it checks for normal operation of the on-board devices of the aircraft, including the devices for transmitting the data to the ground, and to enter an operating mode where it transmits the position should an anomaly be detected.

In this respect, of particular relevance for the purposes of the present invention is the presence, between said systems for transmitting the data to the ground, of a client communication system—also referred to below as LASC client—which is installed in the aircraft and communicates with a server control system—also referred to below as LASC server—which is installed in a control station, for example on the ground. The LASC client may be a portable device, for example a tablet, or integrated in the on-board instrumentation, together with the remaining devices of the aircraft. The LASC client is connected via cable or wirelessly, for example via the NFC/Bluetooth protocol, to the security system.

The LASC client and the LASC server form a communication platform, between control station and aircraft, which is referred to below in short as “LASC platform”. In particular, a plurality of aircrafts which have the client communication system (LASC client) on-board are connected to the server control system (LASC server) via a satellite link (Data-Link) or a cellular network (3G, 4G) or UMTS or the Internet (on-board the aircraft) or VHF Land, and form a network or LASC network. It is envisaged that the client and/or server communication system dynamically changes the type of connection, for example depending on a tariff condition or the presence of one or other network along a certain flight path, passing for example from the satellite link to the Internet or 3G or 4G or other connection.

Thus a function of the security system according to the present invention is to check for correct operation between the LASC client and the LASC server, detect any anomalies and, in the event of anomalies, take over from the LASC client, at least as regards the transmission of the position of the aircraft to the control station, therefore performing a back-up function for the LASC client.

In particular, according to one aspect of the present invention, it is envisaged that the security system of a given aircraft is uniquely linked to the client communication system (LASC client) of the same aircraft and controls correct operation thereof. For example, before take-off of the aircraft, the client communication system (LASC client) checks that the security system in the non-pressurized zone is functioning and/or vice versa; after this check, if everything is functioning correctly, the security system enters into standby mode, remaining possibly in this mode for the entire duration of the flight, but being ready to become operative should an anomaly be detected.

The switch-over from standby mode to the operating mode for detecting and communicating the position may occur in many ways and/or when one or more predetermined conditions exist.

According to one aspect of the invention, it is the server control system (LASC server) of the control station which activates the security system in the non-pressurized section of the aircraft, causing it to switch to the operating mode after detecting interruption of the communication with the client communication system (LASC client) of the aircraft. The LASC server is able to identify immediately the security system by means of the unique code associated with the LASC client with which communication has been lost and communicate with the security system, via the satellite link.

In normal operating conditions, instead, the client communication system (LASC client) communicates with the server control system (LASC server) via various communication “channels” indicated above, including the satellite link or the cellular network (3G, 4G) or UMTS or Internet or VHF Land and it is the LASC client which communicates the position as well as several other data.

In this connection, the client communication system transmits the position of the aircraft and receives from the server control system various data which be advantageously used in place of or in addition to the on-board devices. The data comprises for example virtual instrumentation, preferably associated with a graphic representation, which may be displayed on a device incorporated in the aircraft or in a portable device (tablet, i-pad) and processed by the control station on the basis of various position and/or speed and/or time or other data received from a plurality of stations via the LASC platform (or other present and future platform able to provide this type of interface) which have occupied and/or which are occupying the same air space or space neighbouring that of the aircraft.

According to another aspect of the invention, it is the security system itself which detects the anomalous condition, for example malfunctioning of an on-board device, whether it be the client communication system (LASC client) mentioned above or other on-board device and, in the case of malfunctioning of one of the aforementioned devices, it switches from the standby operating mode to the operating mode for transmitting the position to the control station.

In other words, in the case where the aforementioned client communication system (LASC client) is deactivated, for example following a sudden hijacking with tampering of the on-board devices of the aircraft (including interruption of the power supply sources of the equipment), its sudden deactivation is immediately detected by the control system which switches its operating mode and starts to transmit the position and/or speed data to the control station, thus allowing the control station to never lose track of the aircraft position.

According to one aspect of the invention, after the aircraft has taken off and at predefined intervals, the security system checks the capacity of the LASC platform to transmit. In particular, the security system communicates with the server control system (LASC server) via the satellite link and asks the server to check that the LASC client on-board is correctly functioning; this check may be carried out at predefined intervals or, preferably, only in the case where the security system detects the absence of a (cable and/or wireless) connection with the LASC client associated with it. Said check is carried out in order to exclude that the absence of communication on the aircraft between LASC client and security system is due to sabotage. In this case, i.e. in the absence of a real anomaly or sabotage, it is envisaged that the control system may return into the standby operating mode, after checking that the position is however that provided by the LASC client.

Preferably, therefore, a third and so-called “standby alive” operating mode is envisaged where the control system performs in any case checks as to operation of the LASC client, via the satellite links or other available connections, checking that the position of the aircraft is correctly provided by the LASC client to the LASC server.

The scope of protection of the present invention also includes other modes of activating the security system. For example, the control station may continuously monitor the flight path of the aircraft and compare it with a predefined flight path and activate the security system in the event that the two paths differ beyond a predefined value (for example measured in miles). Alternatively or in combination, the control station may identify an altitude of the aircraft or a continuously varying altitude of the aircraft and compare it with a programmed altitude, interrogating if necessary the servers of an air traffic control system, in order to check whether the aforementioned variations in direction and/or altitude are authorized or not authorized.

According to one aspect of the invention it is envisaged that, in the case where a non-authorized descent is detected, the security system takes over the flight commands, bringing the aircraft into a safe condition, for example to an altitude calculated by the system depending on the presence of obstacles situated below the aircraft and/or of cumulonimbus clouds present in the area and constituting possible threats for the aircraft. It is also envisaged that the aircraft is kept at a given height and/or in a fixed safety direction pending the arrival of interceptor aircraft intended to escort the aircraft back onto the ground.

As mentioned, the security system receives from the satellite system the GPS coordinates, such as the position of the aircraft, and transmits to the control station at least said GPS coordinates. However, it is quite possible for the security system to be equipped with an autonomous inertia system.

Transmission of the coordinates is performed until the on-board devices are restored and begin to communicate again with the control station, for example until the connection between the client communication system (LASC client) of the aircraft and the server control system (LASC server) of the control station is restored or, in the unfortunate case of an aircraft accident, until ground impact occurs.

The term “ground impact” indicates more precisely the case of an aircraft accident, following which the security system may be damaged together with the entire aircraft. Differently, in the case where the aircraft has been hijacked and has landed, therefore coming into contact with the ground without damage, it is envisaged that the communication system continues to transmit the coordinates (position) of the aircraft until landing takes place.

According to one aspect of the present invention, the security system, via its own detection means and/or in combination with the data transmitted from and to the LASC platform, identifies an anomaly as being an inconsistency between the actions performed on-board the aircraft, for example a lowering in altitude, and the planned or authorized flight path, said identification step taking into consideration also the topography of the terrain towards which the aircraft is directed, and therefore determining the anomaly also in the case where the aircraft is flying at a high altitude, but close to mountain peaks which are nevertheless too close to the aircraft and with which there is the risk of collision. In the case of such an anomalous condition being detected, the security system takes over the commands which may be issued by the flight deck and brings the aircraft back into a safe flying condition, for example increasing the power of the engines or increasing the altitude so that it is well above the mountain ranges or no longer on a flight path directed towards buildings or structures. Preferably the security system sets the flight parameters so that the maximum hourly flying autonomy is ensured, at a maximum altitude which is safe for flying, taking into consideration the land area above which the plane is flying, identified via known geographical location systems. The maximum autonomy is set so as to increase the time available for an interceptor aircraft authorized to escort the aircraft.

Powering of the security system is performed constantly under normal operating conditions by means of the BATT Direct Bus of the aircraft. According to the present invention it is envisaged increasing the power autonomy of the security system by means of its integration in or connection to a photovoltaic generator installed on-board or an emergency wind generator which may be controlled directly by the security system depending on predetermined parameters detected, for example, by pneumatic sensors (or other sensors of the prior or future art); said sensors may also be integrated in the security system.

The security system is equipped with a main battery, which is supplied by the BATT Direct Bus, and is further equipped with a back-up battery able to power for various hours the transmission of the position and receive where necessary incoming messages from the control station.

Further characteristic features and advantages of the security system and the associated communication method of the present invention will become clear from the description hereinbelow with reference to a schematic drawing provided purely by way of a non-limiting example.

### BRIEF DESCRIPTION OF THE ATTACHED FIGURES

FIG. 1 shows in schematic form the earth and an aircraft equipped with the security system according to the present invention, during operation when flying around the earth;

FIG. 2 shows in schematic form the aircraft according to FIG. 1.

FIG. 3 shows a block diagram of the security system according to FIG. 1.

### DETAILED DESCRIPTION

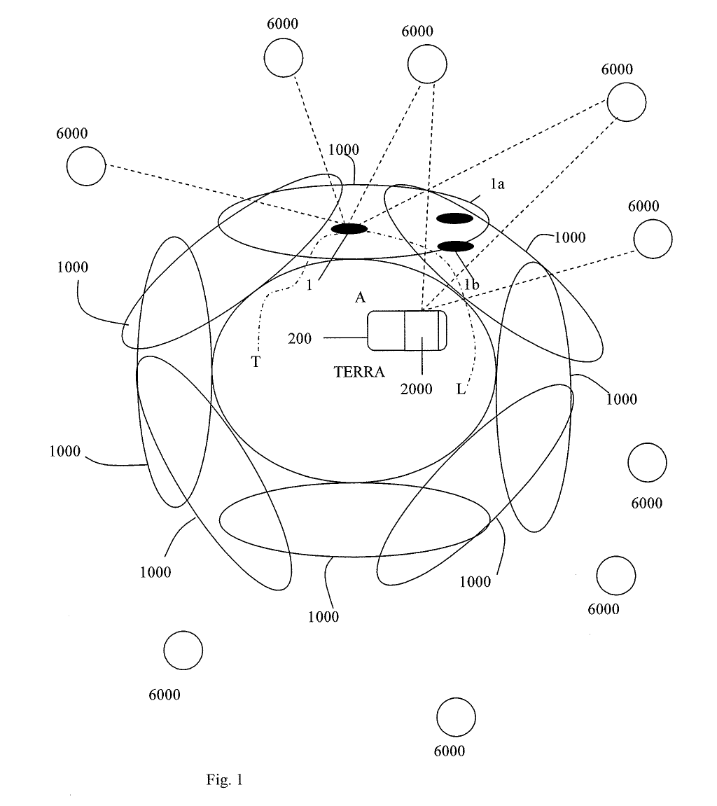

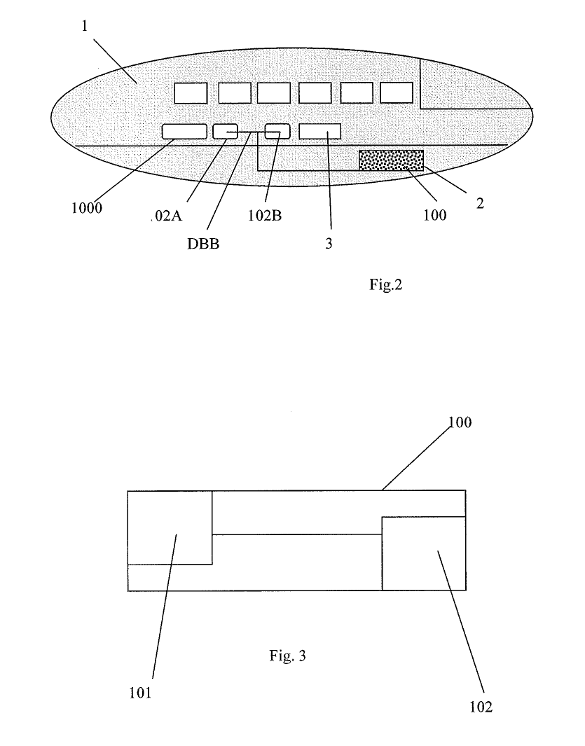

FIG. 1 shows in schematic form an air space 10000 occupied by an aircraft 1 intended to travel along a flight path T-L predefined by a flight schedule. A control station 200 communicates with the aircraft 1 via known devices, for example a primary radar and a secondary radar.

The term “control station 200” is used below in the description to refer not only specifically to a single station, but also to a plurality of stations which are associated with various geographical positions on the earth and which, via said devices, detect the aircraft when it enters into a predetermined range of the station.

In certain conditions, for example in the case of a hijacking, the aircraft 1 may be outside of the detection range of all the control stations 200 on the ground; the same thing may happen if the on-board devices of the aircraft are tampered with or are faulty, for example if a transponder no longer responds to the secondary radar of a control station.

In order to deal with these and other emergency conditions, a communication method according to the present invention envisages the steps of:
installing a security system 100, below also referred to as IDDS, in a zone or section 2 of the aircraft which is not pressurized, said security system 100 comprising a GPS localization device 101 with satellite link and an autonomous battery 102;
detecting in the GPS localization device 101 at least one position A of the aircraft;
sending the position A to the control station 200 interconnected with the satellite link;
   said steps of detecting and sending the position A being performed if an anomaly is detected.

In particular, the method consists in detecting, via the GPS localization device 101 or other technology designed to provide the aforementioned three-dimensional position data (geographical coordinates, speed and altitude), the position A of the aircraft, via the satellite link to satellites 6000 which can be reached by the aircraft 1 within the space 10000, and sending the position A detected to the control station 200 interconnected via the satellite link.

The anomaly comprises, for example, malfunctioning of an on-board device 3 of the aircraft 1 or an unexpected flight path followed by the aircraft 1 or the descent of the aircraft below a predefined altitude or an interruption in a connection between a client communication system 1000 of the aircraft (LASC client) previously connected to a server control system 2000 (LASC server) of the control station 200 via the satellite link or via a 3G, 4G cellular network or UMTS or via the Internet or VHF Land.

The client communication system 2000 is in the pressurized zone of the aircraft, where persons are free to move also while flying, and therefore risks possible damage, for example caused by hijackers.

The client communication system 1000 (LASC client) is portable or incorporated in the aircraft 1 and communicates with the server control system 2000 (LASC server) which is installed in a land or satellite station 200. The LASC client 1000 may be a portable device, for example a tablet, or may be incorporated in the on-board instrumentation, together with the remaining devices 3 of the aircraft and be connected via cable or wirelessly, for example by means of the NFC protocol, to the security system 100. As mentioned, the LASC client 1000 is also connected (during normal operating conditions) to the LASC server via the satellite link or the 3G, 4G cellular network or UMTS or the Internet or VHF Land, and form a network or LASC network. In one embodiment of the present invention, not limiting its scope of protection, the anomaly may be detected by the server control system 2000 (LASC server) and the security system 100 may be activated by the server control system 2000, after detection of the anomaly. Before said activation, the security system 100 is electrically powered, but in a standby operating mode where it uses little electric power and during which it may receive an activation command from the server control system 2000.

According to one aspect of the present invention, the client communication system 1000 is equipped with voice recognition means for detecting a human voice on the aircraft, especially in the cockpit, and is programmed to generate an anomaly signal, in the event that the human voice detected does not correspond to the (pre-recorded) voice of the aircraft commander or his/her subordinates or the persons who have been duly identified and recorded in the LASC client before take-off.

In the case where the LASC client determines a difference between the voice detected and the voices pre-recorded before take-off, the security system 100 is activated so as to communicate the position of the aircraft and receive any remote flying commands from the control station 200. In this way, the security system 100 may immediately react to possible hijacking attempts. In particular, according to the communication method of the present invention, the server control system 2000 or an interceptor aircraft, which has flown up alongside the potentially hijacked aircraft, may send flight information or parameters which constitute remote commands for flying the aircraft; the security system 100 is programmed to exclude the on-board commands of the aircraft 1 and bring the aircraft back down to the ground via the remote flying commands received from the server control system 2000 or from the interceptor aircraft, in the event of an anomaly or hijacking.

In particular, the remote flying commands may be the same flying commands given by a pilot of an interceptor aircraft to the intercepted aircraft, for example in a symmetrical manner as usually occurs with aircraft flying in formation, and transmitted in the immediate vicinity to the security system 100 of the potentially hijacked aircraft.

The remote commands are received by a transceiver system of the aircraft and correspond to the commands given by a pilot of the interceptor aircraft, for example a fighter aircraft equipped in turn with a transceiver system which automatically acquires the commands given by the pilot to the fighter aircraft and transmits them automatically to the aircraft.

Advantageously, according to this aspect of the invention, in order to bring the aircraft back down to the ground, it is not required to have a second pilot on-board the fighter aircraft sending remote commands, but merely one pilot who, via only the commands given to his/her own fighter aircraft, guides both aircraft (fighter and intercepted aircraft).

According to one aspect of the present invention, the interconnection between the commands of the interceptor aircraft and the intercepted aircraft may be encrypted and is any case authorized by means of an encoded electronic identification step performed prior to said interconnection between commands, this step being implemented so as to exclude that unauthorized interceptor aircraft may perform the abovementioned operations in the air space concerned.

In other words, only devices of the interceptor aircraft duly authorized by devices on the intercepted aircraft (and/or vice versa) may be electronically linked together, allowing remote control of the aircraft to be performed.

According to this embodiment, preferably, the security system 100 also comprises a lateral detector of the distance at which the interceptor aircraft is situated, for example based on an ultrasound, optical or magnetic detection method and/or detection of the electromagnetic emission power emitted by the flying object (interceptor plane); the security system 100 is programmed to receive and carry out the flying commands received instead of the pilot's commands, only if the detected distance from the interceptor aircraft is less than a predefined threshold value (for example 50 metres) and excluding therefore possible attempts at hijacking the aircraft based on the sending of flying commands from long distance, for example from a land station or from an aircraft situated far off and not effectively able to position itself alongside as an interceptor aircraft.

Alternatively, the remote commands may be flight parameters transmitted by the interceptor aircraft to the control station 200 and retransmitted by the latter to the security system 100 of the aircraft via the server control system 200, optionally after intervention by a pilot on-ground who converts the flight parameters of the interceptor aircraft into commands for the aircraft.

Obviously, said mode for remote flying of the aircraft 1 can be activated not only by means of the client communication system 1000 (LASC client), as in the example given above with reference to voice recognition, but also in the event of a plurality of other anomalous conditions which may be detected by the LASC client 1000 or by other on-board devices or by remote control systems, including the server control system 2000 (LASC server).

In this connection, the remote flying commands may be sent to the security system 100 also when the LASC client 1000 is not operational. In particular, the security system 100 is designed to receive input from the server control system 2000 (LASC server) even when it is isolated from the LASC client 1000 and, in the event of an anomaly or hijacking, to bypass the control instrumentation of the aircraft situated in the cockpit, for example the Flight Management Computer (FMC), Flight Controls Computer (FCC), Engine Control Computer (ECC), Landing Gear Computer (LGC) or Auto Brake Computer (ABC) or other instruments which, in normal flying conditions, are available to the pilot on-board the aircraft.

Advantageously, according to this aspect of the invention, the security system 100 can be remotely controlled, via the LASC server 2000 or using other systems able to interface with it and guide the aircraft 1 during landing, preventing any hijackers from impeding rescue of the aircraft, since these persons with criminal intent also do not have any possibility of entering and operating within the non-pressurized section in which the security system 100 of the present invention is installed.

According to another aspect of the present invention, the security system 100 is in standby mode, in the absence of an anomaly, and is programmed to detect actively the anomaly in standby mode and enter into an active and operative operating mode, i.e. starting to send the position to the server control system 2000 (LASC server), after detection of the anomaly.

For example, the anomaly in the on-board devices 3 is detected by the security system 100, following disconnection or malfunctioning or sabotage or a fault of one or more of the on-board devices 3 and in particular loss of connection with the client communication system (LASC client).

In particular, after the aircraft 1 has taken off and at predefined intervals, the security system 100 checks the capacity of the LASC platform 1000/2000 to transmit. The security system 100 communicates with the server control system 2000 (LASC server) via the satellite link and asks the server 2000 to check that the LASC client 100 on-board is correctly functioning; this check may be carried out at predefined intervals or, in the case where the security system 100 detects the absence of a (cable and/or wireless) connection with the LASC client 100 associated with it, and is performed substantially in order to exclude that the absence of communication on the aircraft between LASC client 1000 and security system 100 is due to a sabotage. If there is no real anomaly or hijack attempt, the control system 100 returns to standby mode since the position is any case provided by the LASC client; otherwise it starts to detect and transmit the position.

However, several anomalies may be detected in various ways and using various means. For example, an anomalous flight path of the aircraft 1 is detected by the control station 200, by means of a radar or the control system 2000 (LASC server) communicating via the satellite link with the LASC client 1000 of the aircraft 1, operating in non-anomalous conditions. The anomalous flight path is identified owing to its difference from the programmed flight path T-L of the aircraft.

It is also envisaged that the security system 100 can receive, and not only transmit, data from the server control station 2000 (LASC server) of the control station 200. The data received from the control station 200 is displayed on an electronic device 4 on-board the aircraft, for example on the portable device of the LASC client, and interfaced with the security system 100, and in particular is sent in real time, if the electronic device 4 is not in an anomalous condition, or in recorded form, once the electronic device 4 is operational.

At least one position transmitted by the security system 100 to the control station 200 (LASC server) during a malfunction of the LASC client is stored in a memory 103 of the security system 100. All the data thus stored in the memory 103 may be retransmitted onto the LASC client or other on-board devices, once the anomaly, for example the connection of the LASC client to the LASC network, has been resolved/restored. It is also possible for the control system 100 to detect other information, including a speed of the aircraft and/or an altitude and/or flight level, and to transmit it to the LASC server, after detection of the anomaly.

In other words, during the period occurring between isolation of the client communication system and the server control system and the subsequent restoration of the connection, the security system 100 stores a plurality of data received in real time from the server control system, via satellite link and, after said connection has been restored, transmits the data to the client communication system, which may display it in recorded form. This allows the level of security to be significantly improved, for example informing by means of recorded data the personnel on-board that interceptor aircraft have been launched or that action by the aircraft crew is required.

The data received from the control station 200 may be stored in an electronic device 4, incorporated or portable, on-board the aircraft and interfaced with the security system 100. The data may be sent in real time, if the electronic device is not in an anomalous state, or in recorded form, once the electronic system 4 becomes operational again.

The technical problem described above is also solved by a security system 100 according to the present invention, and in particular by a system 100 intended to be installed on an aircraft 1, in a non-pressurized zone, and comprising a GPS localization device 101 with satellite link and a battery 102, and to transmit at least one position of the aircraft to a control station 200 with said satellite like, in the case of an anomaly in the on-board devices.

The system 100 comprises a pneumatic sensor for detecting an altitude of the aircraft and may be programmed to send the position to the control station 200, if the pneumatic sensor detects an altitude lower than a predetermined altitude. The descent below the predefined altitude does not always constitute, per se, a fault or an anomalous flight condition, but activation of the security system 100 when this altitude is reached allows, however, very rapid identification of all the aircraft which are taking off or landing as well as identification of the aircraft which are potentially at said predefined altitude owing to a real problem affecting operation of the aircraft and forcing it to lower its height.

The security system also comprises a device for controlling the flight commands of the aircraft, intended to be mounted on-board the aircraft and to start functioning if an unexpected altitude of the aircraft is identified. The device adjusts autonomously the flight commands so as to guide the aircraft to an altitude or a fixed level, at least until an interceptor aircraft intervenes and escorts the aircraft back onto the ground. Preferably the device also controls the undercarriage of the aircraft and the automatic braking system and adjusts the power of the jet engines.

According to one aspect of the invention, the control device is controlled by a security system (IDDS) mounted on-board an interceptor aircraft which has positioned itself alongside the aircraft. In other words, the two security systems (IDDS) of the aircraft and the interceptor aircraft are electronically linked together during the flight, the commands given to the interceptor aircraft by its pilot are acquired by the security system (IDDS) of the interceptor aircraft and communicated to the security system of the intercepted aircraft (IDDS) which has operational priority, at least during the emergency/anomaly detected, over the commands which may be normally imparted to the aircraft by the flight deck. Said operational priority may be maintained until landing, thus allowing the aircraft to be steered to safety without any possibility of intervention, for example attempt at hijacking with intent to crash the plane, by the person on-board the plane.

The security system 100 comprises heating means, which have the function of preserving correct operation of its electronic components in the non-pressurized zone, where the temperature may be very low, during flying conditions.

The non-pressurized zone is for example a section of the aircraft situated below the flight deck instrumentation; advantageously, by installing the security system underneath this instrumentation, it is possible to obtain an optimum short-range wireless connection, for example via NFC, between the security system 100 and the instrumentation itself. By adopting a cable connection, it is possible to reduce the length of the electric connection cables and increase the precision of the signal.

The security system 100 comprises an interface for connection to the on-board devices 3 and in particular to a client communication system 1000 (LASC client) intended to communicate with a server control system 2000 of the control station 200 via the satellite link or via a 3G, 4G cellular network or UMTS or the Internet or VHF Land. The security system 100 is programmed to be operated to detect and send the position from the server control system 2000, according to the communication method of the present invention, and in particular after detection of the anomaly.

The security system 100 comprises a connection to a back-up battery 5 of the aircraft and/or to a system 6 of main batteries of the aircraft 1 connected to the back-up battery 5 by a Direct Battery Bus and is powered by the main power system 6 or by the back-up battery 5, if available, or by the autonomous battery, if the main battery system 6 or the back-up battery 5 are not available or if a temperature of the back-up battery 5 is higher than a predefined normal operating temperature.

Therefore, the security system 100 is always connected and powered and may always perform an operation for monitoring correct operation of the other on-board devices, including the batteries 102A and 102B, and may start to communicate with the control station 200 and in particular with the LASC server 2000, in the event of the anomaly being detected.

Advantageously, according to the communication method and the security system of the present invention, the aircraft may be always identified by the control station, even with the primary or secondary radar of the aircraft are not functioning or when the aircraft has been diverted outside of the radar range of the stations, since the stations and the aircraft are interconnected by means of a satellite network and since the security system of the aircraft is inaccessible, and therefore may not be interfered with, and is always electrically powered by one of the batteries of the aircraft or the integrated battery.

1. Communication method for an aircraft (1) comprising the steps of:
installing a security system (100 or IDDS) in a non-pressurized zone (2) of the aircraft (1), said security system (100) comprising a GPS localization device (101) with satellite link and an autonomous battery (102);
detecting in the GPS localization device (101) at least one position (A) of the aircraft;
sending the position (A) to a control station (200) interconnected with the satellite link;
said steps of detecting and sending the position (A) being performed if an anomaly is detected.

2. Communication method according to claim 1, characterized in that said anomaly comprises:
malfunctioning of an on-board device (3) of the aircraft or an unexpected flight path followed by the aircraft (1) or a descent of the aircraft below a predefined altitude or an interruption in a connection between a client communication system (1000) of the aircraft, previously connected to a server control system (2000) of the control station (200) via the satellite link or via a (3G, 4G) cellular network or UMTS or the Internet or VHF Land.

3. Communication method according to claim 2, characterized in that said anomaly is detected by said server control system (2000) and said security system (100) is activated by the server control system (2000), after detection of the anomaly.

4. Communication method according to claim 1, characterized in that said security system (100) is in standby mode in the absence an anomaly and is programmed to detect the anomaly in standby mode and to become completely operative, starting to send said position, after detection of the anomaly.

5. Communication method according to claim 2, characterized in that said security system (100) receives information from the server control system (2000) of the control station (200) or from an interceptor aircraft in flight close to said aircraft and in radio communication with the security system.

6. Communication method according to claim 5, characterized by displaying of the data received from the control station (200) on an electronic device (4) on-board the aircraft and interfaced with the security system (100), said data being sent in real time, if the electronic is not in an anomalous condition, or in recorded form, once the electronic system (4) is operational.

7. Communication method according to claim 5, characterized in that the said data received from the server control system (2000) or the interceptor aircraft comprises remote commands for flying the aircraft (1) and in that said security system (100) is programmed to exclude the on-board commands of the aircraft (1) and to steer to the ground the aircraft with said remote flying commands received from the server control system (2000) or from the interceptor aircraft, in the event of an anomaly or hijacking.

8. Communication method according to claim 7, characterized in that the security system (100) detects a distance at which the interceptor aircraft is flying at and executes the remote flying commands only if the detected distance from the interceptor aircraft is less than a predefined threshold.

9. Communication method according to claim 7, characterized in that said remote flying commands are:
the same flying commands given by a pilot of the interceptor aircraft to the intercepted aircraft and are transmitted from the interceptor aircraft to the aircraft (1) via an analog or digital VHF/UHF transceiver system, or
are sent from the server control system (2000) to the security system (100), if necessary after the interceptor aircraft has sent flight parameters to the control station (200) and the flight parameters have been encoded as remote flying commands at the control station (200).

10. Communication method according to claim 1, characterized by storage of at least said position transmitted from the security system (100) to the control station (200) in a memory (103) of the security system (100).

11. Communication method according to claim 1, characterized in that said control system (100) detects and communicates at least one speed of the aircraft and/or an altitude and/or a flight level.

12. Security system (100) of an aircraft (1), comprising a GPS localization device (101) with a satellite link and a battery (102), intended to be installed in an area of the aircraft which is not pressurized, and to transmit at least one position of the aircraft to a control station (200) with said satellite link, in the case of an anomaly.

13. Security system (100) according to claim 12, characterized in that it comprises a pneumatic sensor for detecting an altitude of the aircraft and is programmed to send the position to the control station (200), if the pneumatic sensor detects an altitude lower than an altitude predetermined and/or not envisaged for the aircraft position.

14. Security system according to claim 13, characterized in that it comprises a device for controlling the flight commands of the aircraft and entering into operation if said unexpected altitude is determined, said device adjusting autonomously the flight commands so as to bring the aircraft to a fixed safety level or altitude.

15. Security system (100) according to claim 12, characterized in that it comprises means for heating the non-pressurized zone in which it is installed.

16. Security system (100) according to claim 12, characterized in that said non-pressurized zone is situated below the flight deck instrumentation of the aircraft (1), said security system comprising means for wired or wireless transmission, preferably NFC, with the integrated or portable devices (3) on-board the aircraft (1).

17. Security system (100) according to claim 16, characterized in that said on-board devices (3) comprise a client communication system (1000) intended to communicate with a server control system (2000) of the control station (200) via the satellite link or via a cellular network (3G, 4G) or UMTS or the Internet or VHF Land and in that said security system is programmed to be activated for detection and sending of the position from the server control system (2000), after detection of the anomaly.

18. Security system according to claim 12, characterized in that it comprises a connection to a back-up battery (5) of said aircraft and/or to a system of main batteries (6) of said aircraft connected to said back-up battery (5) by a Battery Direct Bus and that it is powered by said system of main batteries (6) or by said back-up battery (5), if available, or by said autonomous battery, if the system of main batteries (6) or the back-up battery (5) are not available or if a temperature of the back-up battery (5) is greater than a predefined normal operating value.

19. Security system according to claim 18, characterized in that it comprises a photovoltaic generator and/or an emergency wind generator and means for activating said wind generator.

20. Security system according to claim 12, characterized in that it comprises an analog or digital VHF/UHF transceiver system, designed to communicate in radiofrequency with an interceptor aircraft flying close to said aircraft, said security system being programmed to receive remote flying commands from the interceptor aircraft, via said transceiver system, or to receive remote flying commands from said control station, and to exclude the on-board commands of the aircraft and guide the aircraft to the ground on the basis of said remote flying commands.

21. System according to claim 20, characterized in that the remote commands received by the transceiver system correspond to the commands given by the pilot of the interceptor aircraft to the aircraft.
